(19) United States
(12) Patent Application Publication
(10) Pub. No.: US 2012/0278765 A1
(43) Pub. Date: Nov. 1, 2012

(54) IMAGE DISPLAY APPARATUS AND MENU SCREEN DISPLAYING METHOD

(76) Inventor: KAZUKI KUWAHARA, Saitama (JP)

(21) Appl. No.: 13/364,064

(22) Filed: Feb. 1, 2012

(30) Foreign Application Priority Data
Apr. 28, 2011 (JP) 2011-102185

(51) Int. Cl. G06F 3/048

(52) U.S. Cl. 715/841

(57) ABSTRACT

According to one embodiment, an image display apparatus includes: a screen display module displaying a screen on which a category element group and a function element group are displayed in a hierarchy and that allows selection of a element in response to an operation, wherein the category element group corresponds to an upper level of the hierarchy and is formed by arranging elements representing respective categories of various functions, and the function element group corresponds to a lower level of the hierarchy and formed by arranging elements representing respective functions in the category; and a storage storing number information pieces each of which is related to the number of operations of the element, wherein the screen display module is configured to display the screen on which the elements in at least one of the upper and lower levels are arranged according to the number information pieces of the elements.

### CROSS-REFERENCE TO RELATED APPLICATIONS

This application is based upon and claims the benefit of priority from Japanese Patent Application No. 2011-102185, filed Apr. 28, 2011, the entire contents of which are incorporated herein by reference.

### FIELD

Embodiments described herein relate generally to an image display apparatus and a menu screen displaying method.

### BACKGROUND

In recent years, image display apparatuses (such as digital televisions) are being increasingly equipped with multiple and sophisticated functions. Such advancement has made it possible to install various audio/visual (A/V) functions in the image display apparatuses. For example, some of the A/V functions that can be installed are watching and recording/reproducing television broadcast programs; storing contents such as images or music in an internal or external high-capacity recording medium and reading the stored contents for reproducing purposes; and reproducing video and audio programs that are provided via a network.

In the image display apparatuses with multiple and sophisticated functions, a user interface function is provided that displays a list of various functions on a menu screen and allows the user to select any intended function from that menu screen.

In order to enhance the user-friendliness of the user interface function; there exist various techniques such as a technique of changing the shapes or display colors of the icons, a technique of assigning a single direct key or a plurality of keys to functions, and a technique of arranging the icons according to the frequency of use.

In such image display apparatuses in which various functions such as the abovementioned A/V functions can be installed, there is a demand for a user interface function that would allow a user to select an intended function from among various functions by only performing a simple operation.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary external perspective view of a digital television according to an embodiment;

FIG. 2 is an exemplary block diagram of a signal processing system in the digital television in the embodiment;

FIG. 3 is an exemplary functional block diagram of functions implemented by a controller in the embodiment;

FIG. 4 is an exemplary planar view of an outward appearance of a remote controller in the embodiment;

FIG. 5 is an exemplary flowchart of a person identifying processing performed by a person identification module in the embodiment;

FIG. 6 is an exemplary flowchart of a main processing in the embodiment;

FIG. 7 is an exemplary flowchart of an ID conversion processing in the embodiment;

FIG. 8 is an exemplary flowchart of an ID comparing processing in the embodiment;

FIG. 9 is an exemplary flowchart of a menu screen displaying processing in the embodiment;

FIG. 10 is an exemplary flowchart of processing performed at S104 illustrated in FIG. 9;

FIG. 11 is an exemplary front view of a menu screen in the embodiment;

FIG. 12 is an exemplary illustrative diagram of a relationship between a menu category icon group and a menu icon group in the embodiment;

FIG. 13 is another exemplary front view of the menu screen in the embodiment;

FIG. 14 is still another exemplary front view of the menu screen in the embodiment;

FIG. 15 is still another exemplary front view of the menu screen in the embodiment;

FIG. 16 is an exemplary schematic diagram illustrating transition in the embodiment; and

FIG. 17 is another exemplary schematic diagram illustrating the transition in the embodiment.

### DETAILED DESCRIPTION

In general, according to one embodiment, an image display apparatus comprises a menu screen display module and a history storage. The menu screen display module is configured to display a menu screen on which a category selection element group and a function selection element group are displayed in at least a two-level hierarchy and that allows selection of a selection element in response to an operation of an operating device. The category selection element group corresponds to an upper level of the hierarchy and is formed by arranging selection elements representing respective categories of various functions related to image display. The function selection element group corresponds to a lower level of the hierarchy and formed by arranging selection elements representing respective functions in the category. The history storage is configured to store number information pieces each of which is related to the number of operations of the selection element arranged on the menu screen obtained based on an operation history of the corresponding selection element. The menu screen display module is configured to display the menu screen on which the selection elements in at least one of the upper and lower levels are arranged according to the number information pieces of the selection elements.

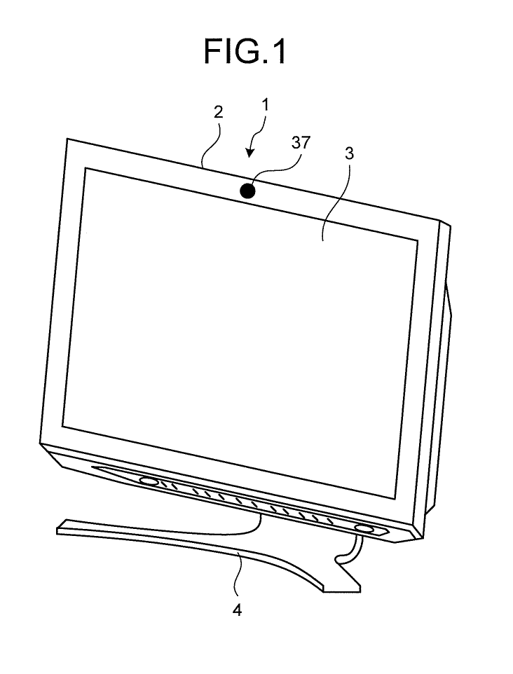

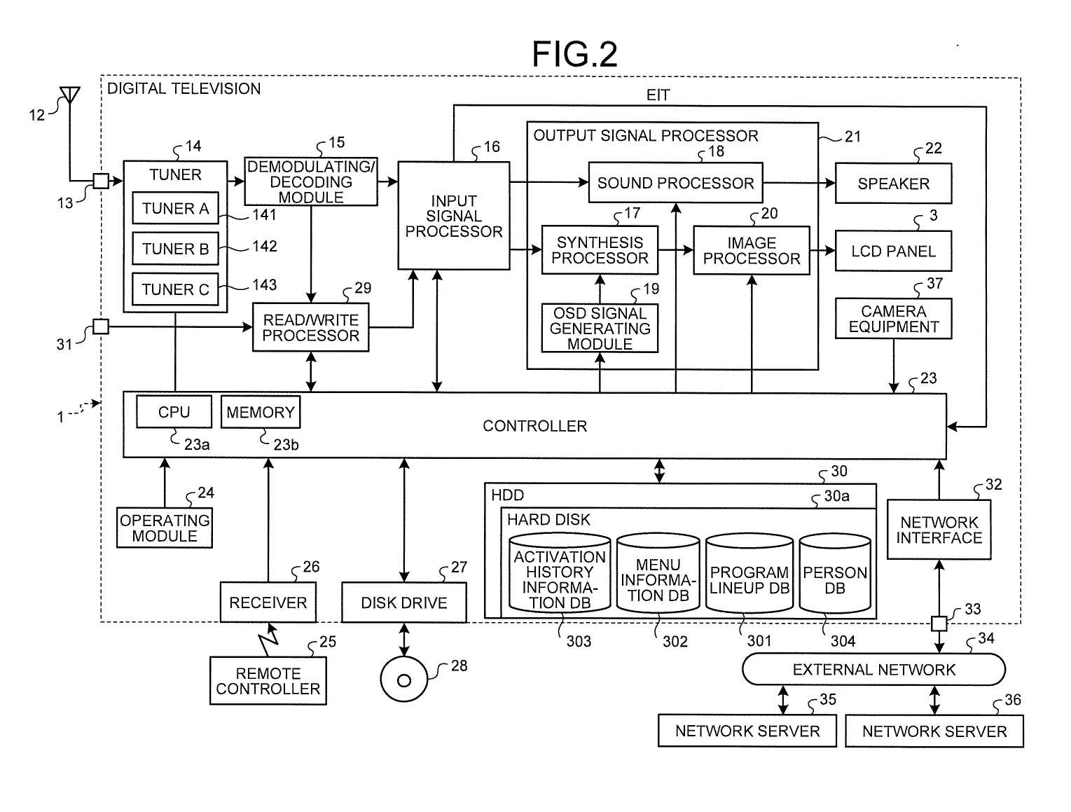

One embodiment will be described in detail hereinafter with reference to some drawings. A digital television serving as an image display apparatus according to the embodiment will be described. FIG. 1 is an external perspective view of the digital television. As illustrated in FIG. 1, a digital television 1 is rectangle in shape when viewed from front in a front view thereof (i.e., when viewed in plan view with respect to the front face). The digital television 1 comprises a housing 2 and a liquid crystal display (LCD) panel 3, which receives video signals from a image processor 20 (see FIG. 2) and displays images including stationary images or videos. Meanwhile, the housing 2 is supported by a support 4.

FIG. 2 is a block diagram of a signal processing system in the digital television 1. As illustrated in FIG. 2, in the digital television 1, digital broadcast signals are received by an antenna 12 and are fed to a tuner 14 serving as a receiver via an input terminal 13. The tuner 14 enables selection of the broadcast signal of an intended channel. The broadcast signal selected at the tuner 14 is fed to a demodulating/decoding module 15, which decodes the broadcast signal into a video signal and a sound signal and outputs those signals to an input signal processor 16. Meanwhile, in the digital television 1 according to the embodiment, the explanation is given for a case of having three tuners 14 (namely, a tuner A 141 and a tuner B 142 for receiving terrestrial digital broadcast, and a tuner C 143 for receiving BS/CS digital broadcast) that serve as the receivers for receiving digital television broadcast signals.

The input signal processor 16 performs predetermined digital signal processing on the digital video signal as well as the digital sound signal fed by the demodulating/decoding module 15.

Besides, from the broadcast signal selected at the tuner 14, the input signal processor 16 separates an event information table (EIT) that contains event information such as the names of programs, the names of performers, and the start timings of programs. Upon being separated from the input signal processor 16, the EIT is input as program lineup data to a controller 23. Herein, the EIT contains the following event information related to programs: program title information or program category information; broadcast details such as performer information; and information such as broadcast date and time.

The input signal processor 16 outputs the digital video signal to a synthesis processor 17 and outputs the digital sound signal to a sound processor 18. On the digital video signal output by the input signal processor 16, the synthesis processor 17 superimposes an on-screen display (OSD) signal, which is a video signal for superimposing, for example, a closed caption, a graphical user interface (GUI), or an OSD, and which is generated by an OSD signal generating module 19, and then outputs the resultant signal. Herein, on the digital video signal output by the input signal processor 16, the synthesis processor 17 superimposes, without modification, the OSD signal generated by the OSD signal generating module 19 and then outputs the resultant signal.

The digital video signal output by the synthesis processor 17 is fed to the image processor 20, which converts the digital video signal into an analog video signal having the format displayable in the LCD panel 3 that functions as a image output module. In the digital television 1, the analog video signal output by the image processor 20 is then fed to the LCD panel 3 for the purpose of image display.

The sound processor 18 converts the digital sound signal input thereto into an analog sound signal having the format that can be reproduced in a latter-stage speaker 22. The analog sound signal output by the sound processor 18 is then fed to the speaker 22 for the purpose of audio playback.

As illustrated in FIG. 2, the synthesis processor 17, the sound processor 18, the OSD signal generating module 19, and the image processor 20 constitute an output signal processor 21.

Besides, as illustrated in FIG. 1, the digital television 1 comprises a camera equipment 37 that is installed in the vicinity of the LCD panel 3 functioning as a image output module. The camera equipment 37 is installed at a position from which it is possible to capture the face of the viewer present in front of the digital television 1.

In the digital television 1, all operations including the abovementioned various receiving operations are comprehensively controlled by the controller 23, which houses therein a central processing unit (CPU) 23a. Upon receiving operation information from an operating module 24 serving as an operating device installed in the main body of the digital television 1, or upon receiving operation information that has been transmitted by a remote controller 25, which also serves as an operating device, and received by a receiver 26; the controller 23 controls the constituent elements in such a way that the contents in the received operation information are reflected.

In that case, the controller 23 makes use of a memory 23b, which mainly comprises a read only memory (ROM) for storing control programs to be executed by the CPU 23a; a random access memory (RAM) for providing a work area to the CPU 23a; and a nonvolatile memory for storing a variety of configuration information, control information, and the operating information received from the operating module 24 or from the remote controller 25.

Moreover, to the controller 23 is connected a disk drive 27, which is used to detachably attach an optical disk 28 such as a digital versatile disk (DVD) and which has the function of performing reading/writing of digital data with respect to the optical disk 28 attached thereto.

Based on the operations performed by a viewer using the operating module 24 or the remote controller 25, the controller 23 can perform control in such a way that the digital video signal and the digital sound signal obtained from the demodulating/decoding module 15 are encoded and converted into a predetermined recording format by a read/write processor 29 and then fed to the disk drive 27 for the purpose of recording in the optical disk 28.

Moreover, based on the operations performed by a viewer using the operating module 24 or the remote controller 25; the controller 23 can perform control in such a way that the digital video signal and the digital sound signal are read from the optical disk 28 by the disk drive 27, decoded by the read/write processor 29, and then fed to the input signal processor 16 for the purpose of image display and audio playback as described above.

Meanwhile, to the controller 23 is connected a hard disk drive (HDD) 30. Based on the operations performed by a viewer using the operating module 24 or the remote controller 25; the controller 23 can perform control in such a way that the digital video signal and the digital sound signal obtained from the demodulating/decoding module 15 are encoded and converted into a predetermined recording format by the read/write processor 29, and then fed to the HDD 30 for the purpose of recording in a hard disk 30a of the HDD 30.

Moreover, based on the operations performed by a viewer using the operating module 24 or the remote controller 25; the controller 23 can perform control in such a way that the digital video signal and the digital sound signal are read from the hard disk 30a by the HDD 30, decoded by the read/write processor 29, and then fed to the input signal processor 16 for the purpose of image display and audio playback as described above.

Upon storing a variety of data in the hard disk 30a; the HDD 30 serves as a program lineup database (program lineup DB) 301, serves as a menu information database (menu information DB) 302, and serves as a person database (person DB) 304. Under the control of the controller 23, the program lineup database 301 is used to store the program lineup data in the form of the EIT, which is separated by the input signal processor 16. Similarly, under the control of the controller 23, the menu information database 302 is used to store menu configuration information that is used in configuring a menu screen M1 (see FIG. 11), which displays icons corresponding to the various functions of the digital television 1. Moreover, under the control of the controller 23, the person database 304 is used to store person data (face data), which is extracted from images by identifying a person using a face recognizing operation, in a corresponding manner to an ID for that person data (person ID).

Meanwhile, in the HDD 30, the number of activations (the number of operations) of each of the icons arranged on the menu screen M1 for a single person is obtained based on respective selection operation histories of the icons. The HDD 30 ranks, in descending order, the numbers of activations of the respective icons for the single person. Thus, the HDD 30 serves as a history storage and stores the information related to the numbers of activations of the respective icons for each of persons as an activation history information database (activation history information DB) 303.

Meanwhile, to the digital television 1 is connected an input terminal 31 that enables direct input of digital video signals and digital sound signals from outside into the digital television 1. The input terminal 31 can be a local area network (LAN) terminal, a universal serial bus (USB) terminal, or a high-definition multimedia interface (HDMI) terminal. Under the control of the controller 23, the digital video signals and digital sound signals input via the input terminal 31 are fed to the input signal processor 16 via the read/write processor 29 for the purpose of image display and audio playback as described above.

Moreover, under the control of the controller 23, the digital video signals and digital sound signals that are input via the input terminal 31 are processed by the read/write processor 29 and are used for the purpose of reading/writing with respect to the optical disk 28 by the disk drive 27 or used for the purpose of reading/writing with respect to the hard disk 30a by the HDD 30.

Meanwhile, based on the operations performed by a viewer using the operating module 24 or the remote controller 25; the controller 23 performs control in such a way that the digital video signals and the digital sound signals recorded in the optical disk 28 by the disk drive 27 are recorded in the hard disk 30a by the HDD 30, and the digital video signals and the digital sound signals recorded in the hard disk 30a by the HDD 30 are recorded in the optical disk 28 by the disk drive 27.

The controller 23 is connected to a network interface 32, which is further connected to an external network 34 via an input-output terminal 33. Besides, to the external network 34, network servers 35 and 36 are connected for the purpose of providing various services with the use of communication functionality via the external network 34. Consequently, via the network interface 32, the input-output terminal 33, and the external network 34; the controller 23 becomes able to access the intended network servers 35 and 36 for the purpose of information communication and becomes able to avail the services provided by the network servers. Meanwhile, to the network interface 32, it is also possible to connect a secure digital (SD) card or a USB device.

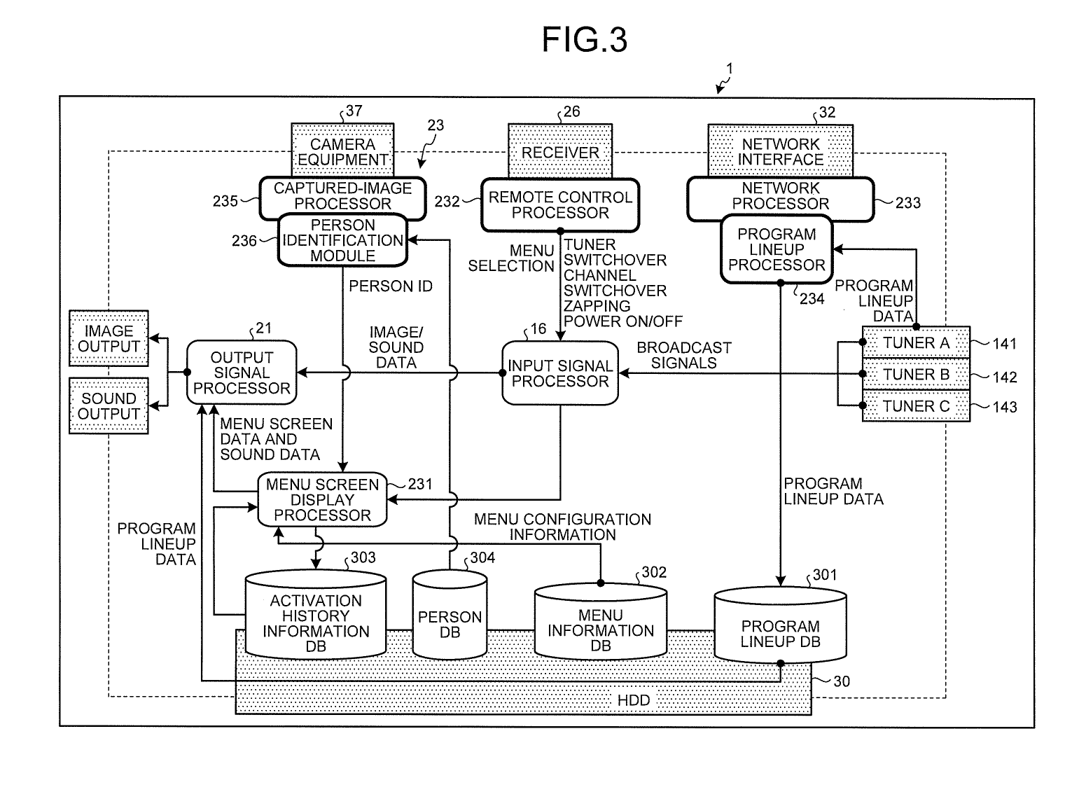

The controller 23 operates according to the instructions given in the control programs and, as illustrated in FIG. 3, implements a menu screen display processor 231 serving as a menu screen display module; a remote control processor 232; a network processor 233; a program lineup processor 234; a captured-image processor 235; and a person identification module 236 serving as a person identification module.

The network processor 233 controls the communication performed through the network interface 32 that is connected to the external network 34 via the input-output terminal 33. Since a plurality of network servers (the two network servers 35 and 36 as illustrated in FIG. 2) are connected to the external network 34 for the purpose of providing various services with the use of communication functionality via the external network 34; the network processor 233 becomes able to access the intended network servers 35 and 36 via the network interface 32, the input-output terminal 33, and the external network 34 for the purpose of information communication, and becomes able to avail the services provided by the network servers.

The captured-image processor 235 processes the images captured by the camera equipment 37. More specifically, as illustrated in FIG. 3, in the digital television 1, the images of a viewer captured by the camera equipment 37 are sent to the person identification module 236 under the control of the captured-image processor 235.

The person identification module 236 extracts person data (face data) from a image by performing a face recognizing operation and identifies the person by performing a face identifying operation. Then, the person identification module 236 cross-checks the extracted person data (face data) with the person database 304, and sends the ID (person ID) of the matching person data (face data) to the menu screen display processor 231. If the person data (face data) does not have a match in the person database 304, the person identification module 236 registers that person data (face data) in the person database 304 and then sends the corresponding person ID to the menu screen display processor 231.

The program lineup processor 234 obtains the EIT (i.e., the program lineup data) separated by the input signal processor 16 and stores the EIT (i.e., the program lineup data) in the program lineup database 301. Alternatively, the EIT (i.e., the program lineup data) can also be obtained via the external network 34. The source from which the EIT (i.e., the program lineup data) is to be obtained is determined according to the user setting. Meanwhile, the program lineup processor 234 has a keyword searching function, which enables searching for a specified keyword with a specified concordance rate in the EIT (i.e., the program lineup data) and sending, to the program lineup database 301, the program lineup data containing programs narrowed down with the searched keyword.

The remote control processor 232 refers to a remote control code sent by the remote controller 25 and received by the receiver 26, and accordingly instructs the input signal processor 16 to perform a power ON/OFF operation, a menu selection operation (described later), a tuner switchover operation or a channel switchover operation (including what is called a zapping operation in which the channels are changed repeatedly). Meanwhile, even in the case when operating information is received from the operating module 24 that is installed in the main body of the digital television 1, the controller 23 controls the constituent elements in such a way that the contents in the received operation information are reflected.

For example, based on an operation performed by the viewer using the operating module 24 or the remote controller 25; the controller 23 can perform control in such a way that the digital video signal and the digital sound signal obtained from the demodulating/decoding module 15 are decoded and converted in a predetermined recording format by the read/write processor 29, and are sent to the HDD 30 for storing in the hard disk 30a.

The menu screen display processor 231 refers to a remote control code (a movement signal corresponding to menu selection) sent by the remote controller 25 and received by the receiver 26, and accordingly obtains the menu configuration information from the menu information database 302; obtains the person IDs from the person identification module 236; and obtains the ranking of the numbers of activations (the numbers of operations), which is the activation history information based on person IDs, from the activation history information database 303; generates menu screen data that serves as a GUI; and sends that GUI to the OSD signal generating module 19.

The values (ranking) of the activation history information stored in the activation history information database 303 are editable to arbitrary values. For that reason, in case the activation history becomes ambiguous, it becomes possible to once delete the activation history information or customize the activation history information according to users (person IDs).

The output signal processor 21 combines image/sound data sent by the input signal processor 16 with the menu screen data and the sound data created by the menu screen display processor 231, and outputs the data for image output and sound output.

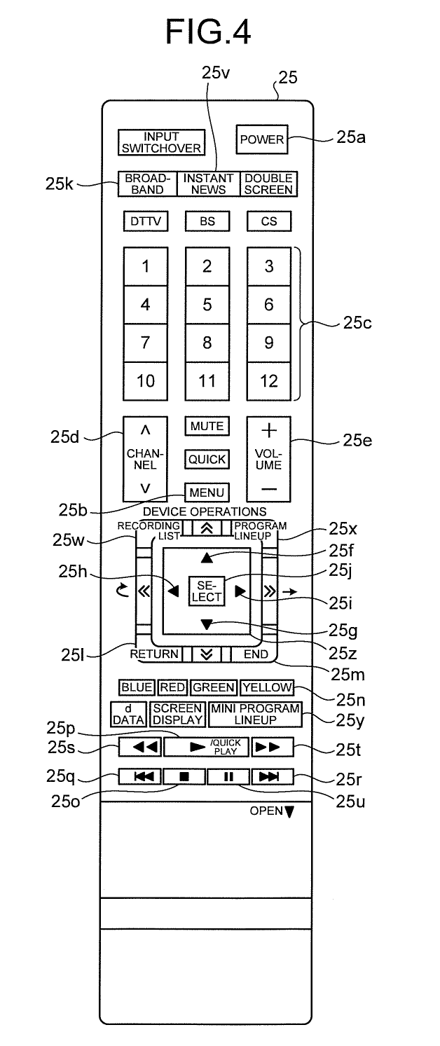

FIG. 4 is a planar view of an outward appearance of the remote controller 25. As illustrated in FIG. 4, the remote controller 25 mainly comprises a power key 25a, a number keypad 25c, a channel selection key 25d, a volume adjustment key 25e, an up-cursor key 25f, a down-cursor key 25g, a left-cursor key 25h, a right-cursor key 25i, a select key 25j, a return key 25l, an end key 25m, and a color key 25n of four colors (blue, red, green, yellow). Herein, the up-cursor key 25f, the down-cursor key 25g, the left-cursor key 25h, and the right-cursor key 25i constitute what is called an arrow key 25z.

Moreover, the remote controller 25 comprises a stop key 25o, a play key 25p, a backward skip key 25q, a forward skip key 25r, a fast-rewind key 25s, a fast-forward key 25t, and a pause key 25u.

Thus, in the digital television 1, with respect to the information in the form of images or sound obtained from the disk drive 27 or from the HDD 30; the stop key 25o, the play key 25p, and the pause key 25u on the remote controller 25 can be operated to perform play, stop, and pause operations, respectively. Similarly, in the digital television 1, by operating the backward skip key 25q or the forward skip key 25r of the remote controller 25; backward skip or forward skip can be performed during which the information in the form of images or sound being played at the disk drive 27 or the HDD 30 can be made to skip by increments in the backward direction or in the forward direction with respect to the play direction. Moreover, in the digital television 1, by operating the fast-rewind key 25s or the fast-forward key 25t of the remote controller 25, fast rewinding or fast forwarding can be performed during which the information in the form of images or sound being played at the disk drive 27 or the HDD 30 can be made to continuously and speedily play in the backward direction or in the forward direction with respect to the play direction.

Meanwhile, the remote controller 25 also comprises a menu key 25b, a broadband key 25k, an instant news key 25v, a recording list key 25w, a program lineup key 25x, and a mini program lineup key 25y.

The menu key 25b is used to display a menu screen having various functions of the digital television 1 as described later in detail.

The broadband key 25k is used to start various browsers for performing broadband functions such as information searching and video services. The instant news key 25v is used to watch the latest news that is automatically recorded in the HDD 30. The recording list key 25w is used to display a recording list so as to allow watching or deleting the programs recorded in the HDD 30. Moreover, the videos stored in the network servers 35 and 36 can also be reproduced.

The program lineup key 25x is used to display a program lineup X that enables watching/recording/programmed recording of programs. The mini program lineup key 25y is used to display, on the downside of the screen on which programs are displayed, a mini program lineup that enables watching/recording/programmed recording of programs.

Explained below in detail are the operations performed by the person identification module 236 and the menu screen display processor 231 that implement the distinguishing functions of the digital television 1 that is an image display apparatus. Herein, the operations performed by the person identification module 236 and the operations performed by the menu screen display processor 231 are carried out in separate processes.

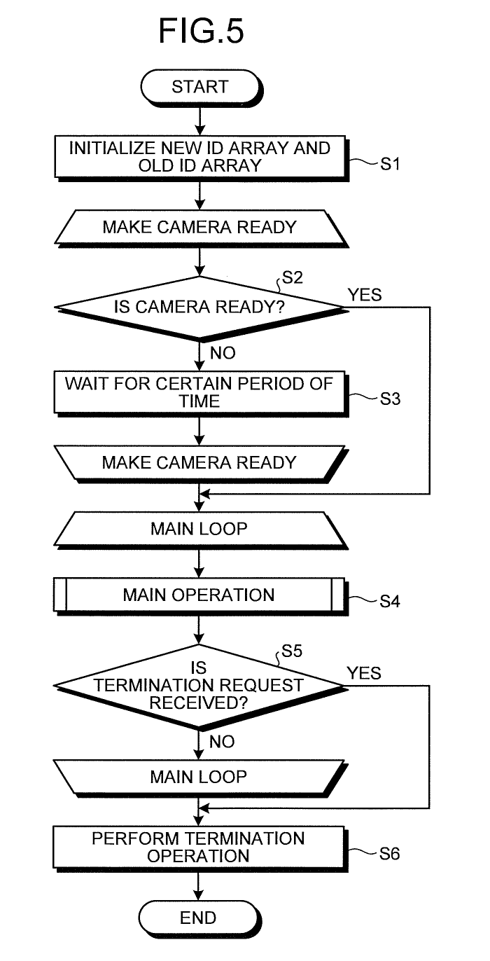

Firstly, explained below in detail with reference to flowcharts in FIGS. 5 to 8 are the operations performed by the person identification module 236, which implements the distinguishing functions of the digital television 1 that is an image display apparatus.

As illustrated in FIG. 5, when the power is switched ON, the person identification module 236 initializes a new ID array and an old ID array, and makes the camera equipment 37 ready for photographing (S1). Herein, the new ID array represents the array of person IDs of the persons watching the digital television 1 at that point of time. The old ID array represents the array of person IDs of the persons who were watching the digital television 1 at a certain point of time in the past (e.g., one minute earlier). The new ID array and the old ID array are stored in the RAM of the memory 23b.

Subsequently, until the camera equipment 37 is ready (No at S2), the person identification module 236 waits for a certain period of time (S3).

Once the camera equipment 37 is ready (Yes at S2), the person identification module 236 performs a main operation (S4) until a termination instruction is received in the form of power-OFF or the like (Yes at S5).

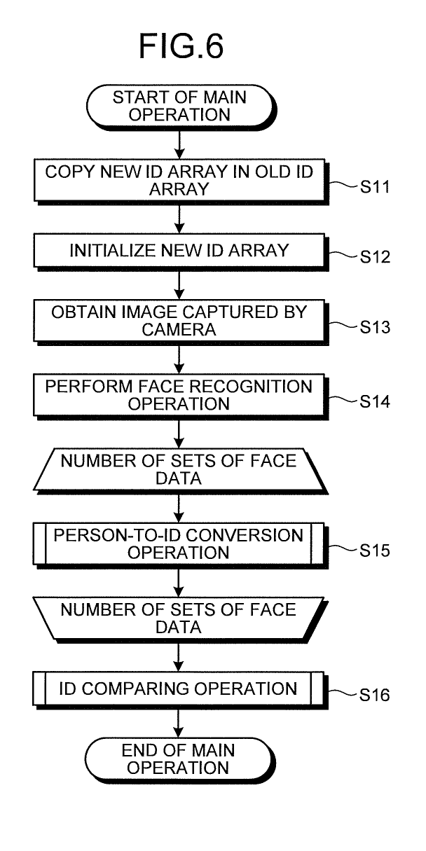

As illustrated in a flowchart for the main operation in FIG. 6, once the camera equipment 37 is ready (Yes at S2), the person identification module 236 copies the new ID array in the old ID array (S11) and initializes the new ID array (S12).

Then, the person identification module 236 obtains a viewer image (image) captured by the camera equipment 37 (S13), extracts the person data (face data) from the viewer image (image) by performing the face recognizing operation (S14), and performs an ID conversion operation (S15).

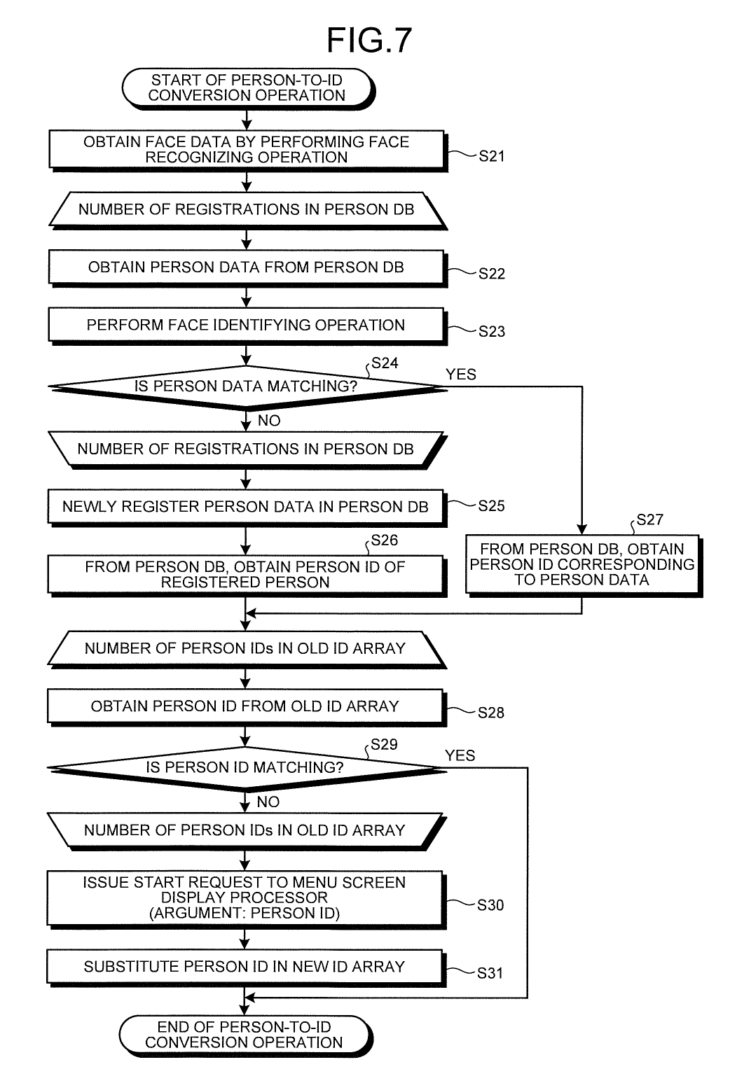

As illustrated in a flowchart for the ID conversion operation in FIG. 7, the person identification module 236 obtains the person data (face data) obtained as the result of the face recognizing operation (S21). Then, regarding that obtained person data (face data), the person identification module 236 obtains person data (face data) from the person database 304 (S22) and performs the face identifying operation for each person (S23).

If it is found in the face identifying operation performed at S23 that any of the obtained person data (face data) is not present in the person database 304 (No at S24); the person identification module 236 registers, in the person database 304, the person data (face data) that has not been found in the person database 304 (S25) and obtains, from the person database 304, the person ID of that registered person data (face data) (S26).

On the other hand, for the obtained person data (face data) that is already present in the person database 304 (Yes at S24); the person identification module 236 obtains, from the person database 304, the person ID corresponding to that person data (face data) (S27).

Subsequently, the person identification module 236 obtains a person ID from the old ID array (S28). If that person ID does not match with the person ID obtained at S26 or S27, that is, if the person ID obtained at S26 or S27 has not been recognized in the previous person recognizing operation (No at S29); then the person identification module 236 sends, to the menu screen display processor 231, a start request for that person ID under the assumption that the corresponding person has started watching (S30) and substitutes the person ID in the new ID array (S31). In this way, when a person recognized in the person identification module 236 is not registered in the person database 304, the person identification module 236 registers the corresponding person data in the person database 304; obtains, from the person database 304, the corresponding person ID that serves as the key for the registered person data (face data); and sends that person ID to the menu screen display processor 231. As a result, the menu screen displaying operation for that person is performed.

On the other hand, if the person ID obtained at S26 or S27 is matching, that is, if the person ID recognized in the previous person recognizing operation is not recognized this time around (Yes at S29); the person identification module 236 substitutes the person ID without modification in the new ID array (S31).

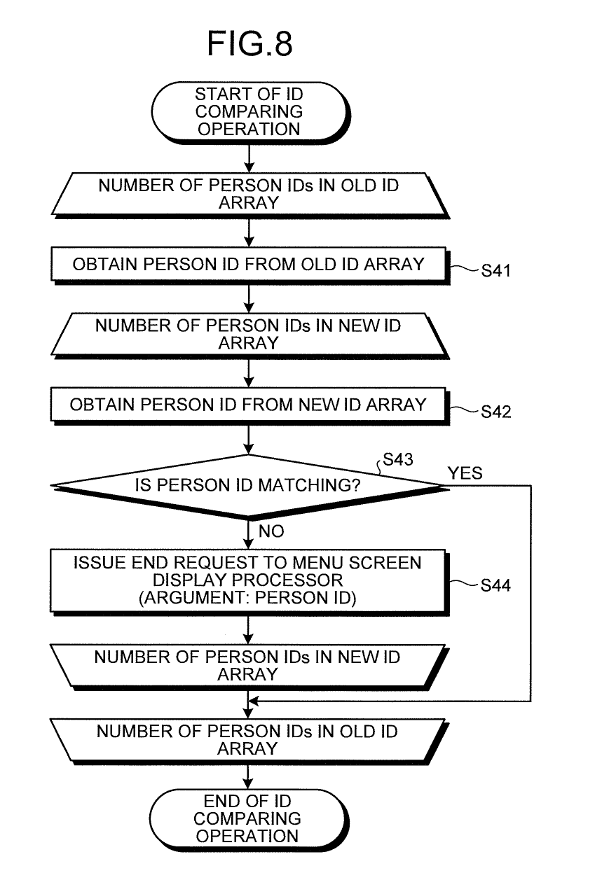

Returning to the explanation with reference to FIG. 6, once the ID conversion operation performed at S15 is complete, the person identification module 236 performs an ID comparing operation (S16). More particularly, as illustrated in a flowchart for the ID comparing operation in FIG. 8, the person identification module 236 obtains the person ID from the old ID array (S41) as well as obtains the person ID from the new ID array (S42). Then, if the person ID recognized in the previous person recognizing operation is not recognized this time around (No at S43); then the person identification module 236 sends, to the menu screen display processor 231, an end request for that person ID under the assumption that the person has finished watching (S44). Thus, if a person that was previously recognized becomes unrecognizable; the person identification module 236 sends, to the menu screen display processor 231, the person ID that serves as the key for the person data of that person who is assumed to have finished watching. As a result, the menu screen displaying operation for that person is finished.

In this way, the person identification module 236 performs the main operation (S4) and, when a termination instruction is issued (Yes at S5), performs a termination operation (S6).

As described above, after obtaining the image captured by the camera equipment 37, the person identification module 236 performs the person recognizing operation and obtains the person data (face data). Then, the person identification module 236 performs the face identifying operation for each person and stores, in the person database 304, the person data (face data) that has not been registered in the person database 304. Subsequently, the person identification module 236 obtains the person ID matching with the person data (face data); and, if that person ID is not recognized in the previous person recognizing operation, sends a start request for that person ID to the menu screen display processor 231. In contrast, if the person ID recognized in the previous person recognizing operation is not recognized this time around, the person identification module 236 sends an end request for that person ID to the menu screen display processor 231. As a result, the person identification module 236 starts the menu screen displaying operation for the newly recognized person and finishes the menu screen displaying operation for the now unrecognizable character.

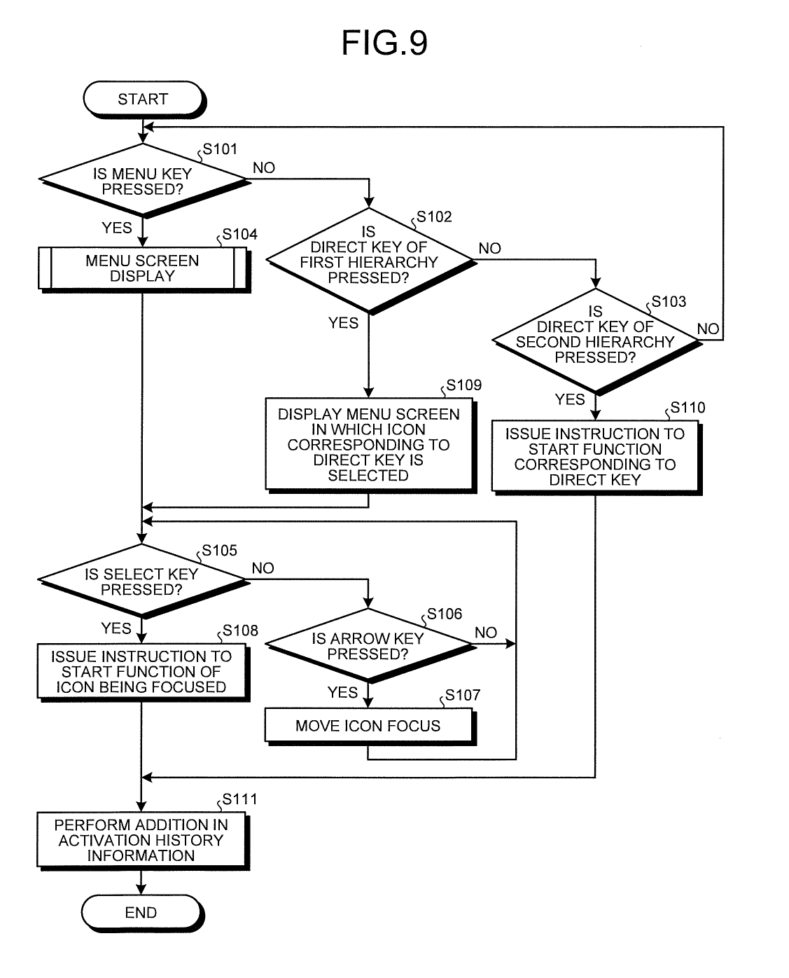

Explained below, with reference to a flowchart illustrated in FIG. 9, is the menu screen displaying operation performed by the menu screen display processor 231, which implements the distinguishing functions of the digital television 1 that is an image display apparatus.

As illustrated in FIG. 9, when it is determined that the menu key 25b of the remote controller 25 is pressed by a user (Yes at S101), the controller 23 (the menu screen display processor 231) displays a menu screen (S104).

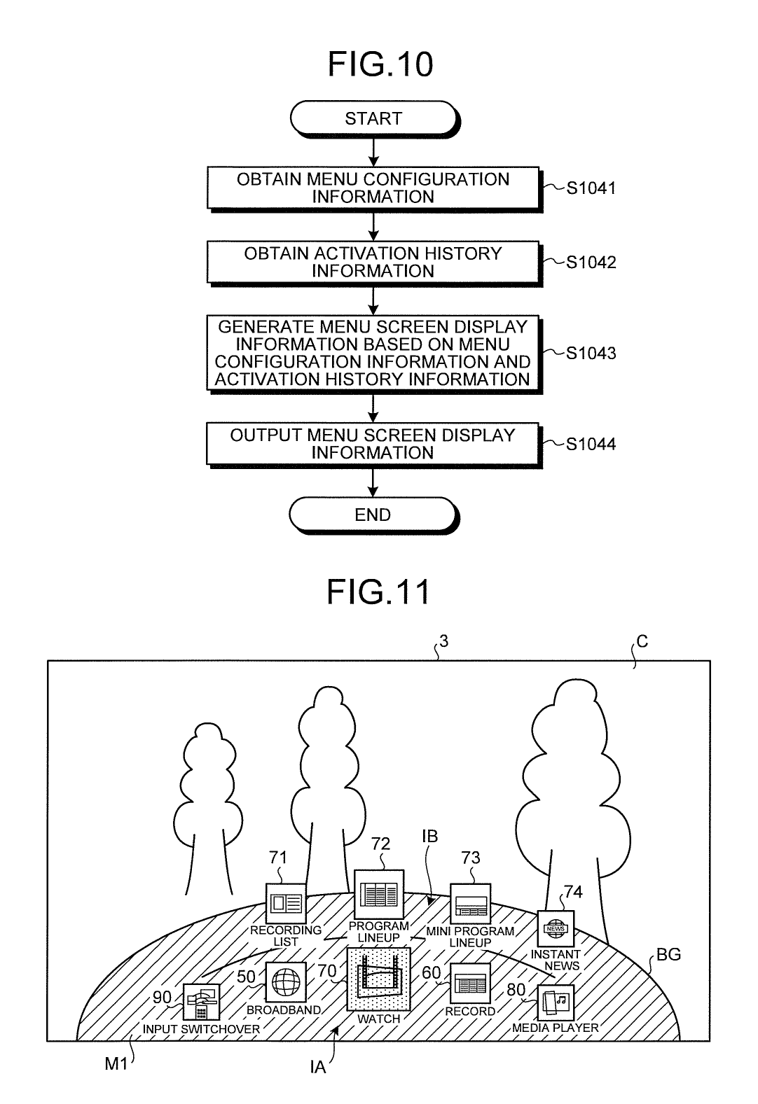

Given below, with reference to a flowchart illustrated in FIG. 10, is the explanation of displaying a menu screen performed at S104. As illustrated in FIG. 10, the controller 23 (the menu screen display processor 231) obtains the menu configuration information from the menu information database 302 (S1041); obtains the activation history information from the activation history information database 303 (S1042); generates, based on the menu configuration information and the activation history information, menu screen display information that is used in displaying a menu screen (S1043); and outputs the menu screen display information to the output signal processor 21 (S1044).

In response to that, the output signal processor 21 outputs the menu screen display information to the LCD panel 3 so that the menu screen Ml illustrated in FIG. 11 is displayed on the LCD panel 3.

The menu screen Ml is displayed superposedly on a reproduction screen C on which contents (such as videos) are reproduced. Herein, the contents that are reproduced can be the contents received via the tuner 14 or the contents stored in the HDD 30.

As illustrated in FIG. 11, the menu screen M1 displayed in the lower part of the reproduction screen C has a menu category icon group (category selection element group) IA comprising icons (selection elements) that represent respective menu categories, that are displayed in various sizes, and that constitute an upper level of a two-level hierarchy; and has a plurality of menu icon groups (function selection element groups) IB, each comprising icons (selection elements) that represent respective functions in each of the menu categories and each constituting a lower level of the two-level hierarchy. Meanwhile, in order to make the menu screen M1 look different than the reproduction screen C of contents and to make the icons more visible, the menu category icon group IA and the menu icon group IB are displayed with a dark background color BG. Meanwhile, the selection elements are not confined to icons and it is also possible to use other images or characters that represent the functions corresponding to each menu category.

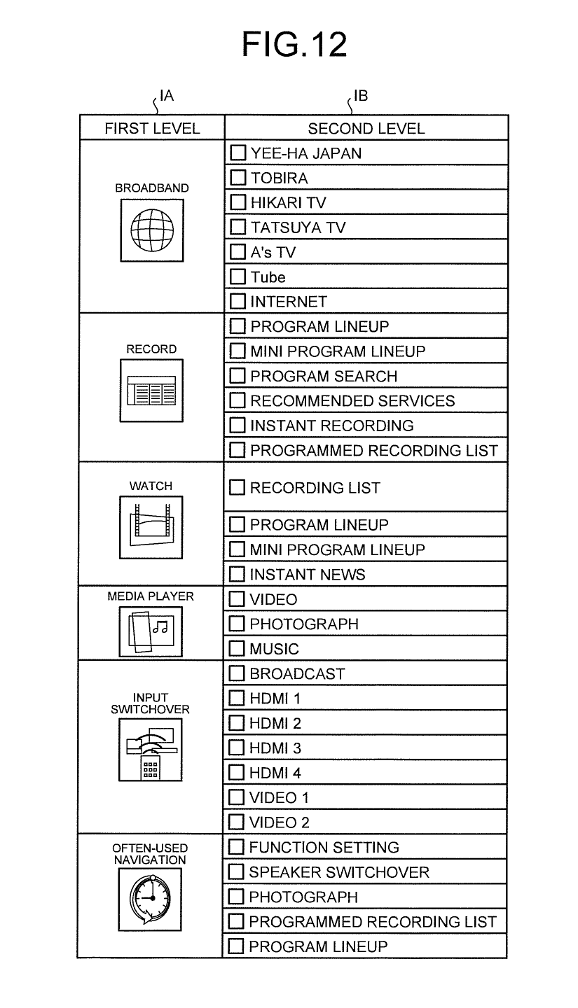

FIG. 12 is an illustrative diagram of the relationship between the menu category icon group IA, which is the upper level (first level), and the menu icon group IB, which is the lower level (second level).

The menu category icon group IA comprises, for example, a “broadband” icon 50, a “record” icon 60, a “watch” icon 70, a “media player” icon 80, and a “input switchover” icon 90.

The “broadband” icon 50 is a shortcut icon representing the menu category for, for example, starting a plurality of network applications (browsers) corresponding to a plurality of network services.

The “record” icon 60 is a shortcut icon representing the menu category for recording/programmed recording of the contents.

The “watch” icon 70 is a shortcut icon representing the menu category for watching the contents.

The “media player” icon 80 is a shortcut icon representing the menu category for, for example, starting a plurality of reproducing applications corresponding to the reproduction of videos/photographs/music stored in an SD memory card, a USB device, or the network servers 35 and 36.

The “input switchover” icon 90 is a shortcut icon representing the menu category for switching the input terminal 31.

For example, in the menu category icon group IA, based on the number of activations for each of the persons, which represent the activation history information stored in the activation history information database 303, with respect to each of the icons in the menu configuration information (the icons representing the respective categories of the various functions), the icon ranked at the top position in the ranking is displayed at the center position in the menu category icon group IA. Further, the icons ranked at top positions in the ranking are displayed in order around the center position in the menu category icon group IA. For example, in the menu category icon group IA illustrated in FIG. 11, the “watch” icon 70 ranked at the top position in the ranking for a specific person in the activation history information is illustrated to have been selected. In that case, the “watch” icon 70 is displayed in an enlarged form of a first size and is highlighted with a brighter background. Besides, the “record” icon 60 that lies on the right side of the selected icon 70 and that is ranked at the second position in the ranking for the specific person in the activation history information and that is a candidate for selection (but not selected yet) is illustrated in a second size smaller than the first size. Similarly, the “broadband” icon 50 that lies on the left side of the selected icon 70 and that is ranked at the third position in the ranking for the specific person in the activation history information and that is a candidate for selection (but not selected yet) is also illustrated in the second size smaller than the first size. Moreover, the “media player” icon 80 that lies on the right side of the selection candidate icon 60 ranked at the second position and that is ranked at the fourth position in the ranking for the specific person in the activation history information and that is a candidate for selection (but not selected yet) is illustrated in a third size smaller than the second size. Similarly, the “input switchover” icon 90 that lies on the left side of the selection candidate icon 50 ranked at the third position and that is ranked at the fifth position in the ranking for the specific person in the activation history information and that is a candidate for selection (but not selected yet) is also illustrated in the third size smaller than the second size. As mentioned above, the icons other than the icon ranked at the top position for the specific person are arranged in the order of the ranking for the specific person near the position where the icon ranked at the top position in the ranking for the specific person is arranged. Since the user is highly likely to repeatedly perform the same operations, such an arrangement of icons makes it easier for the user to select an intended function from among the various functions.

The menu icon group IB illustrated in FIG. 11 is given as an example when the “watch” icon 70 is selected from the menu category icon group IA. When the “watch” icon 70 is selected, the menu icon group IB comprises a “recording list” icon 71, a “program lineup” icon 72, a “mini program lineup” icon 73, and an “instant news” icon 74.

The “recording list” icon 71 is used to display a recording list so as to allow watching or deleting the programs recorded in the HDD 30. Herein, the “recording list” icon 71 has the same function as that of the recording list key 25w.

The “program lineup” icon 72 is used to display the program lineup X that enables watching/recording/programmed recording of programs. Herein, the “program lineup” icon 72 has the same function as that of the program lineup key 25x.

The “mini program lineup” icon 73 is used to display, on the downside of the reproduction screen C, a mini program lineup that enables watching/recording/programmed recording of programs. Herein, the “mini program lineup” icon 73 has the same function as that of the mini program lineup key 25y.

The “instant news” icon 74 is used to watch the latest news that are automatically recorded in the HDD 30. Herein, the “instant news” icon 74 has the same function as that of the instant news key 25v.

For example, in the menu icon group IB, based on the number of activations for each of the persons, which represent the activation history information stored in the activation history information database 303, with respect to each of the icons in the menu configuration information (the icons representing the respective functions), the icon ranked at the top position in the ranking is displayed at the center position in the menu icon group IB. Further, the icons ranked at top positions in the ranking are displayed in order around the center position in the menu icon group IB. For example, in the menu icon group IB illustrated in FIG. 11, the “program lineup” icon 72 ranked at the top position in the ranking for the specific person in the activation history information is displayed in of the first size. Besides, the “mini program lineup” icon 73 that lies on the right side of the “program lineup” icon 72 and that is ranked at the second position in the ranking for the specific person in the activation history information and that is a candidate for selection (but not selected yet) is illustrated in the second size smaller than the first size. Similarly, the “recording list” icon 71 that lies on the left side of the “program lineup” icon 72 and that is ranked at the third position in the ranking for the specific person in the activation history information and that is a candidate for selection (but not selected yet) is also illustrated in the second size smaller than the first size. Moreover, the “instant news” icon 74 that lies on the right side of the selection candidate icon 73 ranked at the second position and that is ranked at the fourth position in the ranking for the specific person in the activation history information and that is a candidate for selection (but not selected yet) is illustrated in the third size smaller than the second size. As mentioned above, in the embodiment, in both the menu category icon group IA and the menu icon group IB, the icons other than the icon ranked at the top position for the specific person are arranged in the order of the ranking for the specific person near the position where the icon ranked at the top position in the ranking for the specific person is arranged. However, it is not limited to this. Instead of this, in at least one of both the menu category icon group IA and the menu icon group IB, the icons other than the icon ranked at the top position for the specific person can be arranged in the order of the ranking for the specific person near the position where the icon ranked at the top position in the ranking for the specific person is arranged.

Meanwhile, in the digital television 1, an “often-used navigation” icon 100 is also provided as part of the menu category icon group IA. The “often-used navigation” icon 100 is a shortcut icon representing the menu category for displaying, on the same level of the hierarchy, the often activated/selected functions. As compared to the “broadband” icon 50, the “record” icon 60, the “watch” icon 70, the “media player” icon 80, and the “input switchover” icon 90; the “often-used navigation” icon 100 is different in the following respect. As illustrated in FIG. 12, for the “broadband” icon 50 or the like that falls in the menu category icon group IA of the upper level (first level), the menu icon group IB at the lower level (second level) is defined in advance. In contrast, for the “often-used navigation” icon 100, the menu icon group IB of the lower level (second level) is determined based on the activation history information stored in the activation history information database 303 of the HDD 30.

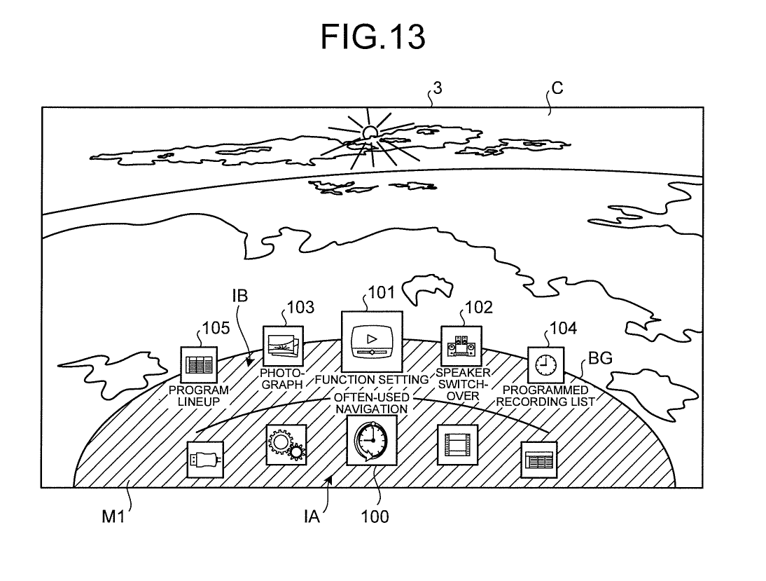

FIG. 13 is a front view of an example of the menu screen. In FIG. 13, it is illustrated that the menu icon group IB is displayed due to the selection of the “often-used navigation” icon 100 from the menu category icon group IA. During the period when the “often-used navigation” icon 100 is selected, the menu icon group IB comprises a “function setting” icon 101, a “speaker switchover” icon 102, a “photograph” icon 103, a “programmed recording list” icon 104, and a “program lineup” icon 105.

For example, in the menu icon group IB illustrated in FIG. 13, based on the number of activations for each of the persons with respect to each of the icons in the menu configuration information (the icons representing the respective functions), the icon ranked at the top position in the ranking is displayed at the center position in the menu icon group IB. Further, the icons ranked at top positions in the ranking are displayed in order around the center position in the menu icon group IB. For example, in the menu icon group IB illustrated in FIG. 13, the “function setting” icon 101 ranked at the top position in the ranking for the specific person in the activation history information is displayed in of the first size. Besides, the “speaker switchover” icon 102 that lies on the right side of the “function setting” icon 101 and that is ranked at the second position in the ranking for the specific person in the activation history information and that is a candidate for selection (but not selected yet) is illustrated in the second size smaller than the first size. Similarly, the “photograph” icon 103 that lies on the left side of the “function setting” icon 101 and that is ranked at the third position in the ranking for the specific person in the activation history information and that is a candidate for selection (but not selected yet) is also illustrated in the second size smaller than the first size. Moreover, the “programmed recording list” icon 104 that lies on the right side of the “speaker switchover” icon 102 ranked at the second position and that is ranked at the fourth position in the ranking for the specific person in the activation history information and that is a candidate for selection (but not selected yet) is illustrated in the third size smaller than the second size. Similarly, the “program lineup” icon 105 that lies on the left side of the “photograph” icon 103 ranked at the third position and that is ranked at the fifth position in the ranking for the specific person in the activation history information and that is a candidate for selection (but not selected yet) is also illustrated in the third size smaller than the second size.

In the menu screen M1 illustrated in FIGS. 11 and 13, by operating the left-cursor key 25h and the right-cursor key 25i constituting the arrow key 25z of the remote controller 25 (No at S105, Yes at S106), it becomes possible to move the focus among the icons in the menu category icon group IA (S107). More particularly, the remote controller 25 outputs a movement signal (remote control code) corresponding to the operation (menu selection) of the arrow key 25z. The remote control processor 232 receives the movement signal and, based on the movement signal, the menu screen display processor 231 controls the movement of focus among the icons.

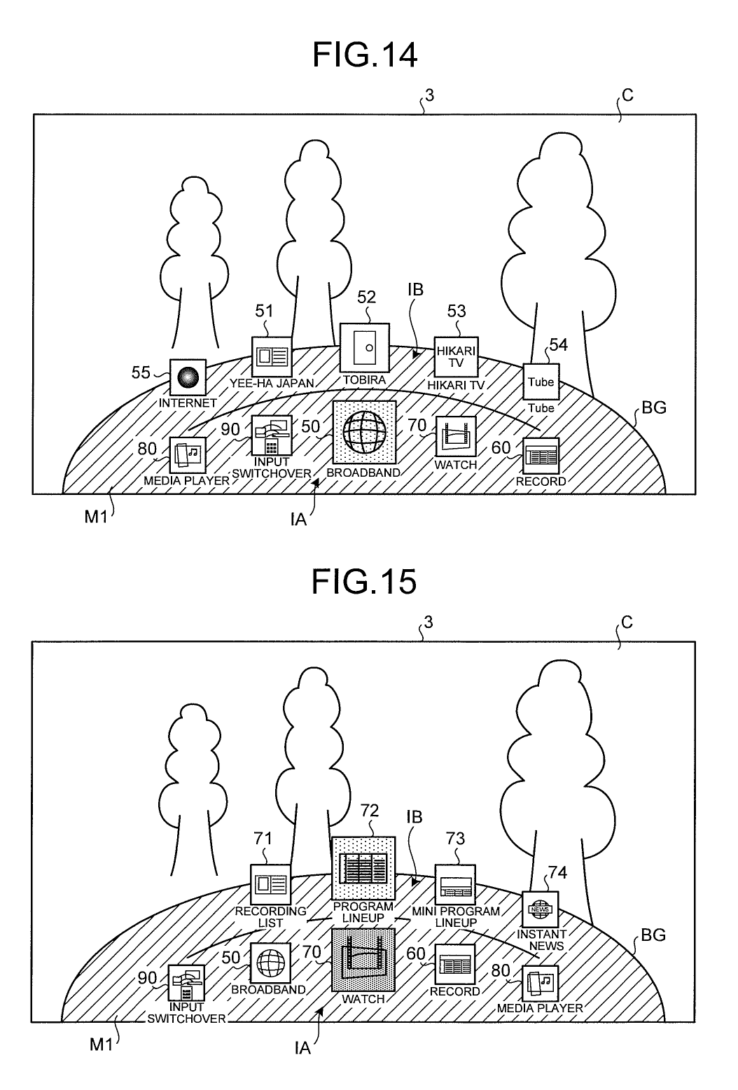

FIG. 14 illustrates a case in which, by operating the left-cursor key 25h constituting the arrow key 25z of the remote controller 25, the focus is moved from the “watch” icon 70 illustrated in FIG. 11 to the “broadband” icon 50. As illustrated in FIG. 14, the newly-selected “broadband” icon 50 is displayed in an enlarged form of the first size and is highlighted with a brighter background.

Moreover, as illustrated in FIG. 14, while the “broadband” icon 50 in the menu category icon group IA is selected, the menu icon group IB comprises a “yee-ha JAPAN” icon 51, a “tobira” icon 52, a “hikari TV” icon 53, a “tube” icon 54, and an “Internet” icon 55. Herein, around the “tobira” icon 52 ranked at the top position in the ranking for the person of the activation history information, the icons are arranged in descending order of the number of selections or activations. Meanwhile, there are seven menus associated to the “broadband” icon 50. Thus, within a display count (assumed to be five) allotted for the menu icon group IB, the menu screen display processor 231 displays those seven menus in a cyclic manner. Herein, the display count (function count) for the menu icon group IB displayed on the menu screen M1 can be set in an arbitrary manner.

Meanwhile, in the menu screen M1 illustrated in FIG. 11, by operating the up-cursor key 25f constituting the arrow key 25z of the remote controller 25 (No at S105, Yes at S106); it becomes possible to move the focus from the icons in the menu category icon group IA to the icons in the menu icon group IB (S107).

FIG. 15 illustrates a case in which, by operating the up-cursor key 25f constituting the arrow key 25z of the remote controller 25, the focus is moved from the “watch” icon 70 illustrated in FIG. 11 to the “program lineup” icon 72. As illustrated in FIG. 15, the newly-selected “program lineup” icon 72 is displayed in an enlarged form of the first size and is highlighted with a brighter background. On the other hand, the “watch” icon 70 is displayed by reducing it to the first size and displayed with only a somewhat bright background.

When the broadband key 25k, which is a direct key in the first level, of the remote controller 25 is selected by the user (Yes at S102); the controller 23 (the menu screen display processor 231) generates, based on the menu configuration information, the menu screen display information for displaying the menu screen, and outputs the menu screen display information to the output signal processor 21 (S109). Herein, the broadband key 25k is used to start various browsers for performing broadband functions such as information searching and video services, and represents a specific function in the first level illustrated in FIG. 12. Thus, by selecting the broadband key 25k of the remote controller 25, the controller 23 (the menu screen display processor 231) generates the menu screen display information for displaying the menu screen M1 illustrated in FIG. 14. Herein, as illustrated in FIG. 14, in the menu screen Ml displayed due to selection of the broadband key 25k, the “broadband” icon 50 is displayed in an enlarged form of the first size and is highlighted with a brighter background.

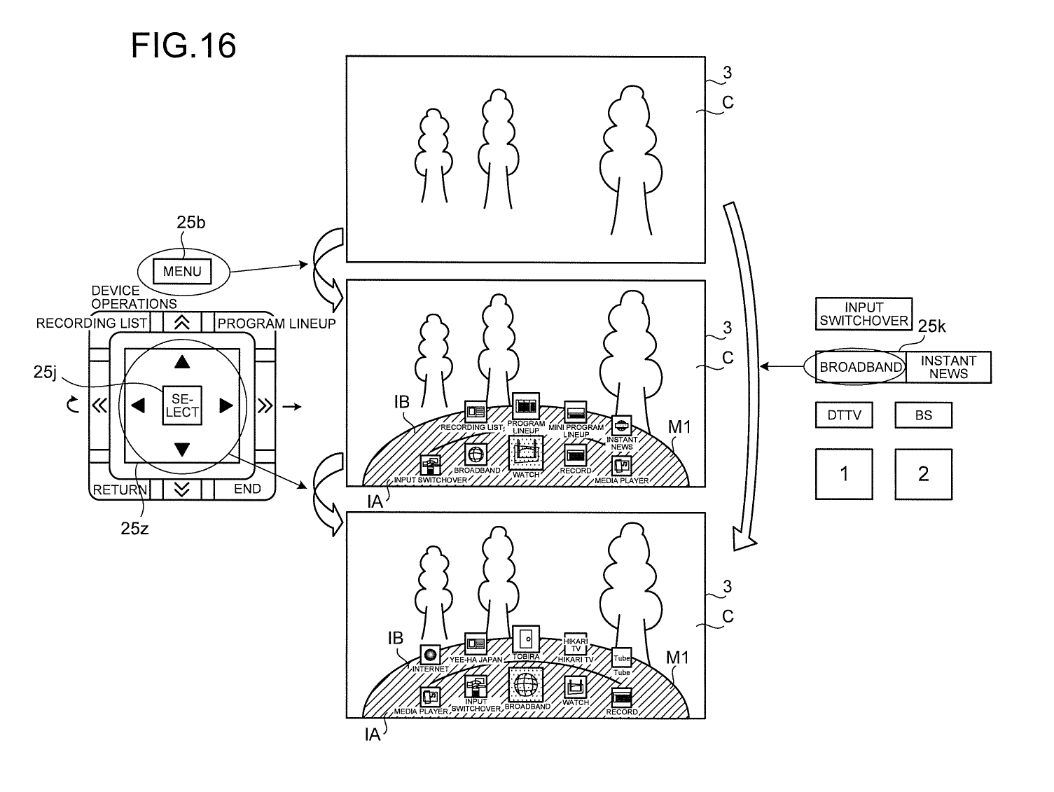

FIG. 16 is a schematic diagram illustrating transition to a specific function in the first level by the selection of the menu key 25b and the arrow key 25z and illustrating transition to a specific function in the first level by the selection of a direct key.

As illustrated in FIG. 15, in the menu screen M1 in which a menu icon in the second level is selected; if the select key 25j of the remote controller 25 is operated (Yes at S105), an instruction is issued to start the function of the icon being focused (S108). In FIG. 15, since the “program lineup” icon 72 is being focused; the output signal processor 21 displays, on the LCD panel 3, the program lineup X based on the program lineup data stored in the program lineup database 301.

Moreover, as illustrated in FIG. 15, in the menu screen M1 in which a menu icon in the second level is selected; in order to return to the selection of menu category from the menu category icon group IA in the first level, the down-cursor key 25g in the arrow key 25z of the remote controller 25 can be operated (Yes at S106).

Besides, in response to the user selection of a direct key in the second level such as the instant news key 25v, the recording list key 25w, the program lineup key 25x, or the mini program lineup key 25y of the remote controller 25 (Yes at S103); an instruction is issued to start the function corresponding to the selected key (S110). Herein, each of the instant news key 25v, the recording list key 25w, the program lineup key 25x, and the mini program lineup key 25y is used in instructing the start of the corresponding function and represents a specific function in the first level illustrated in FIG. 12. For example, by selecting the program lineup key 25x of the remote controller 25; the output signal processor 21, displays on the LCD panel 3, the program lineup X based on the program lineup data stored in the program lineup database 301.

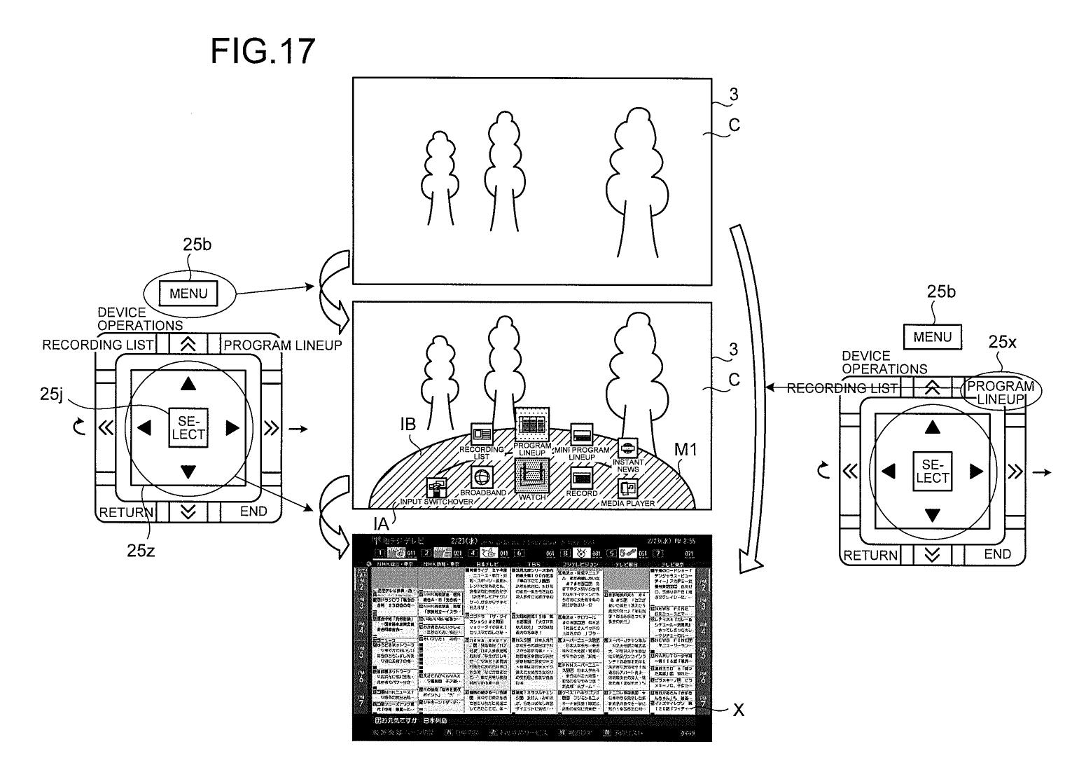

FIG. 17 is a schematic diagram illustrating transition to a specific function in the second level by the selection of the menu key 25b and the arrow key 25z and illustrating transition to a specific function in the second level by the selection of a direct key.

Lastly, regarding the function for which a start instruction is issued at S108 or at S110, the controller 23 (the menu screen display processor 231) adds only one to the number of activations (the number of operations) with respect to the activation history information corresponding to the person stored in the activation history information database 303 of the HDD 30 (S111), and ends the operation. At the time of adding the number of activations; the controller 23 (the menu screen display processor 231) ranks, in descending order, the number of activations (the number of operations) corresponding to the person and obtained based on the selection operation history regarding the icons arranged on the menu screen M1.

In this way, the digital television 1 functioning as an image display apparatus according to the embodiment comprises the menu screen display processor 231 which functions as a menu screen display module for displaying the menu screen M1 and the activation history information database 303. On the menu screen M1 the icons representing the respective categories of various functions or representing the respective functions related to image display are arranged in a hierarchy. The menu screen M1 allows selection of the icons in response to an operation of an operating device. The activation history information database 303 stores number information pieces each of which is related to the number of operations of the icon on the menu screen M1 obtained based on the operation history of the corresponding icon. Regarding the arrangement of the icons in at least one level, the menu screen display processor 231 arranges the icons according to the number information pieces. As a result, it becomes possible to put into practice a user interface function that allows the user to easily select the functions from the menu screen M1, in which arbitrary functions from among various functions are arranged in a hierarchy.

Moreover, in the digital television 1 functioning as an image display apparatus according to the embodiment, keeping records of the frequency of use of the functions makes it possible to display the often used functions together in a menu.

Furthermore, in the digital television 1 functioning as an image display apparatus according to the embodiment, the focus is invariably kept on the most often used function and the other functions are arranged in descending order of the frequency of use at positions having a less number of selection steps from the focus. That enables achieving enhancement in the user-friendliness.

Besides, in the digital television 1 functioning as an image display apparatus according to the embodiment, the users are identified by using the camera equipment 37 and the frequency of use for each user is figured out. Accordingly, the usage display priority for each user is changed. As a result, even when the digital television 1 is used by family members of a family, the usage information can be prevented from becoming ambiguous. Meanwhile, in the embodiment, the user identification is performed on the basis of extracting the person data (face data) from the images by means of a face recognition operation and on the basis of performing person identification by means of a face identification operation. However, alternatively, user identification can also be performed by reading ID cards each having a unique ID assigned to the corresponding user. Still alternatively, user identification can be performed by means of manually inputting the unique ID of each user.

Moreover, in the digital television 1 functioning as an image display apparatus according to the embodiment, when a signal is received from such a direct key in the operating device that is assigned for one of the functions displayed by icons in the lower level, an instruction is issued to start the function corresponding to that directed key. Hence, even for the users who are used to performing operations using the direct keys, it becomes possible to put into practice a user interface function that allows the user to easily select the functions.

Meanwhile, the control programs executed in the digital television 1 that functions as an image display apparatus according to the embodiment can be provided in the form of an installable or executable on a computer-readable recording medium such as a compact disk read only memory (CD-ROM), a flexible disk (FD), a compact disk readable (CD-R), or a DVD.

Alternatively, the control programs executed in the digital television 1 that functions as an image display apparatus according to the embodiment can be saved as downloadable files on a computer connected to a network such as the Internet or can be made available for distribution through the network.

Herein, the control programs executed in the digital television 1 that functions as an image display apparatus according to the embodiment contain modules for implementing the functions of the abovementioned constituent elements (the menu screen display processor 231, the remote control processor 232, the network processor 233, the program lineup processor 234, the captured-image processor 235, and the person identification module 236). Regarding the actual hardware, the CPU (processor) retrieves the control programs from the ROM and runs them so that the control programs are loaded in a main memory device. As a result, the functions of the menu screen display processor 231, the remote control processor 232, the network processor 233, the program lineup processor 234, the captured-image processor 235, and the person identification module 236 are implemented in the RAM.

Meanwhile, in the embodiment, the explanation is given with reference to the digital television 1 that functions as an image display apparatus. However, alternatively, the image display apparatus can also be implemented as a hard disk drive (HDD) recorder, a tuner, a set-top box, or the like.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image display apparatus comprising:
a menu screen display module configured to display a menu screen on which a category selection element group and a function selection element group are displayed in at least a two-level hierarchy and that allows selection of a selection element in response to an operation of an operating device, wherein the category selection element group corresponds to an upper level of the hierarchy and is formed by arranging selection elements representing respective categories of various functions related to image display, and the function selection element group corresponds to a lower level of the hierarchy and formed by arranging selection elements representing respective functions in the category; and
a history storage configured to store number information pieces each of which is related to the number of operations of the selection element arranged on the menu screen obtained based on an operation history of the corresponding selection element, wherein
the menu screen display module is configured to display the menu screen on which the selection elements in at least one of the upper and lower levels are arranged according to the number information pieces of the selection elements.

2. The image display apparatus of claim 1, further comprising a person identification module configured to identify a person who performs an operation on the selection element arranged on the menu screen, wherein
the history storage is configured to rank the functions selected by the operations on the selection elements that are performed by the person identified by the person identification module to generate a ranking and configured to store the ranking as the number information pieces.

3. The image display apparatus of claim 2, wherein the menu screen display module is configured to display, in a same level of the upper and lower levels, the selection elements ranked at top positions in the ranking.

4. The image display apparatus of claim 2, wherein, the menu screen display module is configured to display the selection element ranked at a top position in the ranking at a center position in a single one of the upper and lower levels, and display, in order, the selection elements ranked at top positions in the ranking around the center position in the single one of the upper and lower levels.

5. The image display apparatus of claim 1, wherein the menu screen display module is configured to be able to set the number of the selection elements arranged in a single one of the upper and lower levels arbitrarily.

6. The image display apparatus of claim 1, wherein the history storage is configured to allow editing of the number information piece.

7. A menu screen displaying method comprising:
displaying, by a menu screen display module, a menu screen on which a category selection element group and a function selection element group are displayed in at least a two-level hierarchy and that allows selection of a selection element in response to an operation of an operating device, wherein the category selection element group corresponds to an upper level of the hierarchy and is formed by arranging selection elements representing respective categories of various functions related to image display, and the function selection element group corresponds to a lower level of the hierarchy and formed by arranging selection elements representing respective functions in the category; and
storing, by a history storage, number information pieces each of which is related to the number of operations of the selection element arranged on the menu screen obtained based on an operation history of the corresponding selection element, wherein
the displaying includes displaying the menu screen on which the selection elements in at least one of the upper and lower levels are arranged according to the number information pieces of the selection elements.

8. The menu screen displaying method of claim 7, further comprising, further comprising identifying, by a person identification module, a person who performs an operation on the selection element arranged on the menu screen, wherein
the storing includes ranking the functions selected by the operations on the selection elements that are performed by the person identified by the person identification module to generate a ranking and storing the ranking as the number information pieces.

9. The menu screen displaying method of claim 8, wherein the displaying includes displaying, in a same level of the upper and lower levels, the selection elements ranked at top positions in the ranking.
